(19) United States
(12) Patent Application Publication
(10) Pub. No.: US 2016/0329859 A1
(43) Pub. Date: Nov. 10, 2016

(54) SOLAR PANEL RACKING ARRAY

(71) Applicant: POWERAK PTY LTD, Sippy Downs, Queensland (AU)

(72) Inventors: George Jaroslav Cap, Maleny (AU); William M. Fries, Saint George, UT (US)

(21) Appl. No.: 15/109,010

(22) PCT Filed: Jan. 5, 2015
(86) PCT No.: PCT/AU2015/000001

§ 371 Date: Jun. 29, 2016

(30) Foreign Application Priority Data
Jan. 2, 2014 (AU) 2014900009
May 16, 2014 (AU) 2014901814

(51) Int. Cl. H02S 20/23; H02S 30/10; H02S 20/30

(52) U.S. Cl. CPC H02S 20/23; H02S 20/30; H02S 30/10

(57) ABSTRACT

A commercial modular solar racking system, with the capability to be assembled in several configurations, which when assembled, creates a adaptable, size variable, solar panel supporting infrastructure, with a rapid assembly time. The said modular system can be adapted, to construct a perimeter wind lift-dampening fence around the deployed array. This modular rack array for supporting solar panels includes solar panel hold down clips; a longitudinal support rack which is securable to a roof and which has two longitudinal sides with solar panel support ledges on both sides and hold down clip receiving recesses located between each row of support ledges the arrangement enabling a single solar panel to be supported by two parallel support racks and additional panels to be supported by an additional support rack with the panel hold down clips being arranged to be secured to the support racks by clipping into the receiving recesses in said support racks and bearing down on the upper side of the solar panel edges so that two parallel edges of said solar panel are held between the hold down clips and the support ledges of said support racks. The invention also provides a residential modular racking system for pitched roofs, with the capability to incrementally adjust to suit any large PV panel size. The system is based on four, quarter size racks sliding into each other providing the variability. Each support module for supporting solar panels on pitched roofs has connection projections on two adjoining sides and on the two opposed adjoining sides are complementary connection recesses so that the modules are interconnectable.

This invention relates to a modular solar racking system. This invention addresses the problems of installation time and wind stability of installed arrays particularly on roof tops.

### BACKGROUND TO THE INVENTION

Patent WO2000012839 discloses a solar panel roof mounting system. This system appears complex and time consuming to assemble. This system relies on under tile fixing and the inherent system weight. There is no lower fixing mechanism to address fixing from the facia side of the roof, and further: The strapping mechanism has no inherent North-South & East-West, cross-fixing mechanism. The fixing system is a non-tensioned system. The straps are illustrated fixed to the top tile battens, The system without the necessary cross tensioning, and strong, stable fixing points, will not endure medium-to-high wind speeds, and would predictably oscillate/vibrate/lift when affected by variable wind gusts.

For some time there has been interest in the use of thermoplastics for the design of solar racking systems.

Renusol Solar Mounting Systems have developed a console mounting system. The console is basically a hollow [or shelled] triangular prism with un-equal sides and no base. The console is designed to support solar panels in landscape mode via lips and protrusions around the perimeter of the said base. There is no inter-module vertical and/or horizontal separating system the product does however have a special adaption for high wing or seismic conditions. Ballast is required and added to the interior of the prism as pavers or aggregate.

The triangular prism is injection moulded from HDPE [both virgin and regrind], in several configurations depending on the required latitude angle.

Sollega Produce Two Types of Systems:

1. A PV panel single side support consisting of a moulded shelled vertical plank, with two moulded triangular prisms—one at the lower end of the plank and the other at the opposite. The tops of the prisms have embedded metal plates where fixing screws can fix solar panel frames. The tops of the said prisms are parallel and of varying heights to support the solar panel at the desired inclination angles. Each said side support can fix two edges of a solar panel.

2. This product is similar to the initial with the exception that the moulding supports a whole solar panel and not one side—essentially it is two product l's moulded with an in between area that can be used to hold ballast.

As with the Renusol system, with both of the said products: there is no inter-module vertical and/or horizontal systematic separating system and no tendon fixing system. Ballast is needed and added to the interior between the uneven prisms as pavers. The triangular prism is injection moulded from HDPE [both virgin and/or regrind], in several configurations depending on the required latitude angle.

The PV-Pod, Is another variation of the triangular prism design, with a central horseshoe shaped cut out within the prism. The prism is enclosed however, so that the pod can be ballasted via filling with water. There are top and bottom pilot hole bosses that will accept strapping screws that connect inter-module and inter rows. Again, there is no inter-module vertical and/or horizontal systematic separating system and no tendon fixing system. Ballast is needed and added to the interior between the uneven prisms as pavers.

The triangular prism is blow/rotor moulded from HDPE [both virgin and/or regrind], in several configurations depending on the required latitude angle. PCT/AU2013/000102 discloses a racking system that can be used on roof tops and is adapted to satisfy the US EPA LT2 rule.

U.S. Pat. No. 8,733,036 discloses a panel support for a solar panel which may be connected to other such panels.

U.S. Pat. No. 8,756,881 discloses an attachment device for securing an array of solar panels to a roof.

U.S. Pat. No. 8,732,940 discloses a pair of rails adapted to support a plurality of solar panels on a support structure.

U.S. Pat. No. 8,776,454 discloses a mounting rail for supporting an array of solar panels.

It is an object of this invention to provide a commercial solar generator racking system that is easy to install and ameliorates the disadvantages of the prior art. It is a secondary object of this invention to provide a domestic racking system.

### BRIEF DESCRIPTION OF THE INVENTION

To this end the present invention provides a modular rack array for supporting solar panels which includes

Solar Panel Hold Down Clips

a longitudinal support rack which may be securable to a roof and which has two longitudinal sides with solar panel support ledges on both sides and hold down clip receiving recesses located between each row of support ledges

the arrangement enabling a single solar panel to be supported by two parallel support racks and additional panels to be supported by an additional support rack with the panel hold down clips being arranged to be secured to the support racks by clipping into the receiving recesses in said support racks and bearing down on the upper side of the solar panel edges so that two parallel edges of said solar panel are held between the hold down clips and the support ledges of said support racks. The first major part of the present invention consists of a longitudinal support rack or thermoplastic ‘Truss rack’, [or T-rack], which is designed such that two racks are needed to support the first solar panel, thereafter one rack is needed for each extra panel, as each T-rack can support two solar panels. This means that the rack to PVP ratio is:

$$\frac{{( T \text{-} rack )}^{Number ( n )}}{{( SolarPanel )}^{Number ( n )}} = [ \frac{n + 1}{n} ] .$$

Which as n becomes large becomes 1:1.

The T-rack wedge shaped design evolved conceptually from its simplicity and strength. The wedge enable s the solar panels to be inclined to the vertical. The wedge perimeter frame provides the required connectivity to the roof—through the base, and to the PV panels through the top wedge face. A central web was incorporated to assist applied force transfer to the base. A PV panel fixing system requiring minimal adjustment but applicable to all solar panels was devised to fix the solar panels to the T-rack, and moulded into the top wedge face. Front and rear slide-n-lock mechanisms were devised to connect the T-rack back-to-back and front-to-front—to complete a design requirement and to assist in the deployment speed of the array. Ribs were added to strengthen the lateral deflection of the rack under load, and web cut outs were made in non-structural areas to reduce the inherent weight of the part increasing its cost effectiveness.

In a preferred embodiment the wedge shaped T racks incorporate circular flanges at each end of the base of the T rack to accommodate tubular connecting pieces to laterally connect the T racks into an array. The tubular connectors may be filled with water or other material such as sand to provide ballast. In this form the arrays may not need to be tethered to a roof or other support structure.

The need for securing the array to a roof or support is usually required to avoid the effects of wind which can create an up lift force on the array.

In another aspect this invention provides A modular rack array for supporting solar panels which includes
a longitudinal wedge shaped support rack which has two longitudinal sides with solar panel support ledges on both sides and incorporate circular flanges at each end of the base of the rack to accommodate tubular connecting pieces to laterally connect the support racks into an array;
tubular connecting pieces;
a fence panel mounted on the tubular connecting pieces and said fence has a blunt front mesh type air-foil profile with a wind porosity requirement.

A truncated T-rack was designed preferably to (if needed) support a perimeter fence panel. The fence panel incorporates adaptations for either the T-rack or the truncated T-rack to fix singly or on both sides on one [the first], end of the fence panel if more support is required. Extruded tongues were moulded on the other end of the fence panel, to provide connectivity and thermal expansive release via slots cut into the first end of the next connected panel. The fence panel is designed to be 60% porous with sinusoidal form factor to maximise its ameliorating effectiveness on wind loads. The fence panel is incorporated with tongue and groove adaptations together with fixing boltholes so that it can be assembled in a corral formation. Preferably the fence panel has a blunt front mesh type air-foil profile with a specific wind porosity requirement. The air foil profile is preferably curved back over the rack array.

This PV panel fixing system may be applied to a pitched roof racking system.

For pitched roofs this invention provides a support module having connection projections on two adjoining sides and on the two opposed adjoining sides are complementary connection recesses so that the modules are interconnectable. The adapted system comprises four, quarter [or Q] rack parts with biscuit protrusions and their conjugate receptacles positioned in such positions so as to provide a connective vertical and horizontal adjustment to suit larger size panels. The said design may be easily adapted to suit any solar panel design requirement. A slot and block mechanism and insert-able clip was devised to lock the required rack size in position via 2.5 mm increments.

Four symmetric fixing points are moulded in the Q-rack to accept a standard off the shelf wire strainer for fixing to tiles of shingled roofs. Slotted extrusions were moulded at the four corners and an off set strip providing vertical fixing points for metal and other non tiled penetrable roofs. The solar panels are connected via a fixing clip, which clips over a perimeter bar and separated via perimeter castling around each Q-rack.

Advantages of this invention include:
a) T Rack:
   a. An injected moulded modular set of parts, which when assembled, form long back-to-back, and front-to-front assembled solar racking lines including a wind turbulence suppressing perimeter fence;
   b. An adjustable longitudinal angle pitching system allowing for fixing to low angle, long curves, and slow sinusoid profile deployments, maximising power to deployment area and its curvature;
   c. Minimum deployment [roof] fixing points for low latitude, low wind speed non cyclonic areas;
   d. Array wind pressure equalisation via perimeter fencing for high wind, non cyclonic areas;
   e. Optional temporary or permanent—perimeter, localised or total ballasting in high value wind risk areas;
   f. Fixing of PV panels in both landscape or portrait orientation;
b) Both solar commercial and pitched roof racking systems are adaptable to suit a large size variation of solar PV panels;
c) The material type and manufacturing process of both solar racking array systems provide the advantages of addressing specific quick fit interlocking designs only possible with injection moulded parts, which dramatically accelerate support array and solar panel attachment assembly times;
d) The T-racks [or truncated part types], may be attached to the fence part, as an adaption, to ameliorate wind turbulence;
e) All white rack assembly parts are preferably master-batched with Rutilian [type], Titanium dioxide, to provide maximum reflectivity of light. This together with minimal air space obstruction and a white roof surface provides optimum conditions for dual sided Solar Panels.

### DETAILED DESCRIPTION OF THE INVENTION

A preferred embodiment of the invention will be described with reference to the drawings in which:

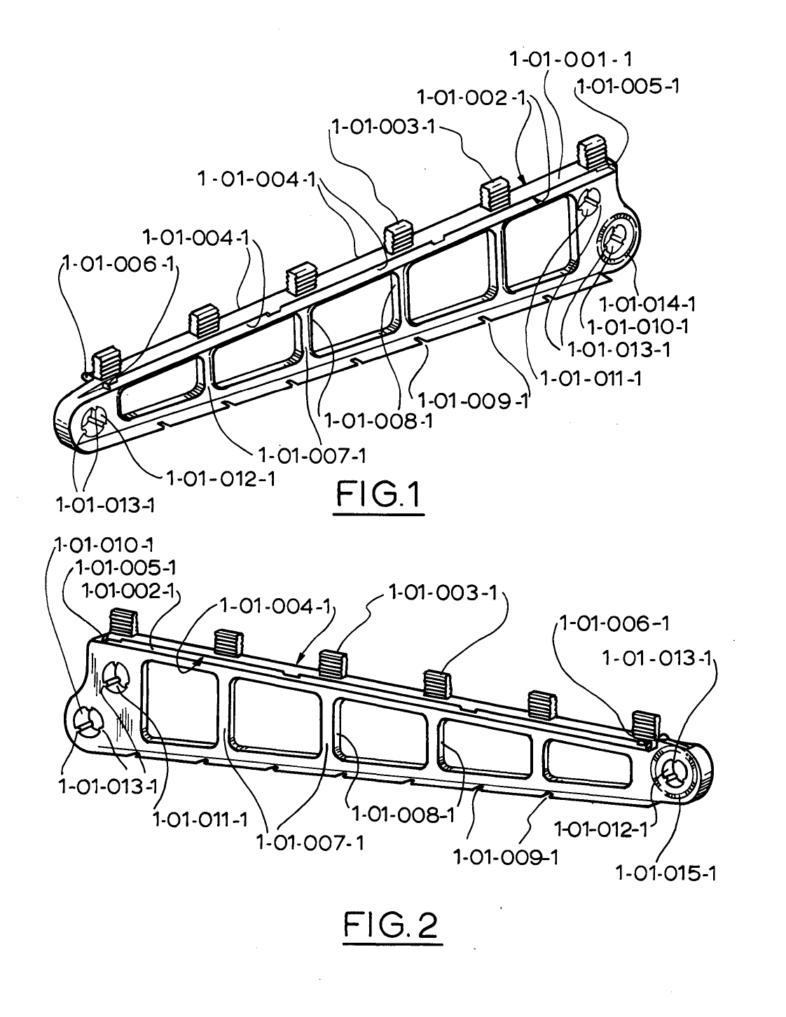

FIG. 1 illustrates a RHS isometric view of the Truss Rack;

FIG. 2 illustrates a LHS isometric view of the Truss Rack;

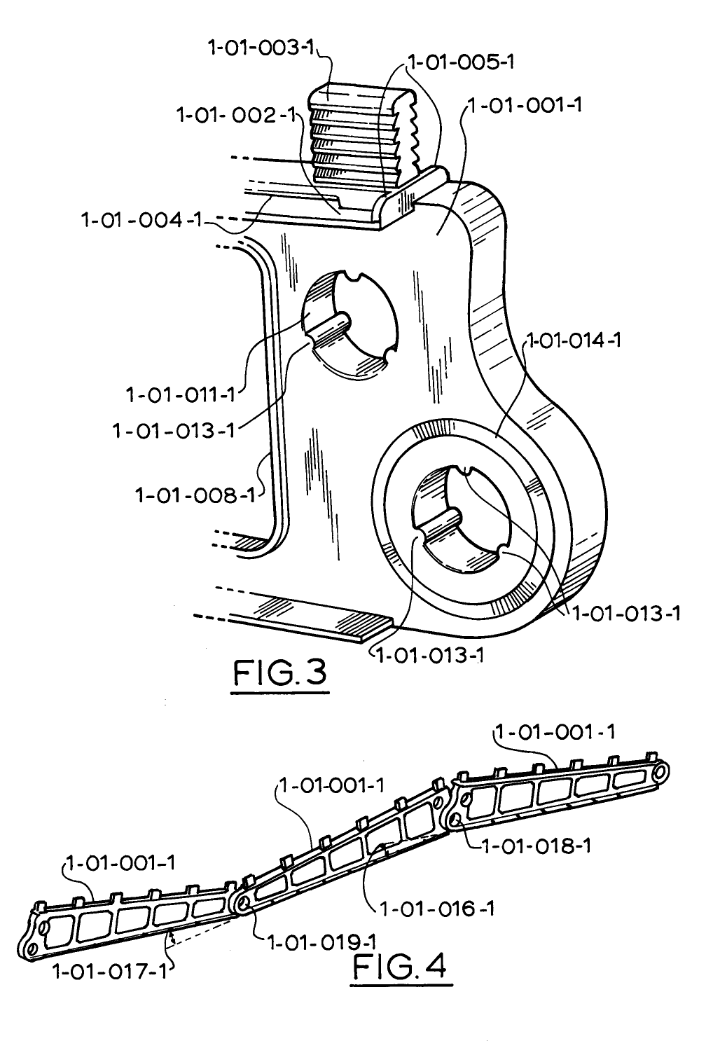

FIG. 3 illustrates a magnified view of the larger end of FIG. 1;

FIG. 4 illustrates three truss racks assembles front-to-front and back-to-back;

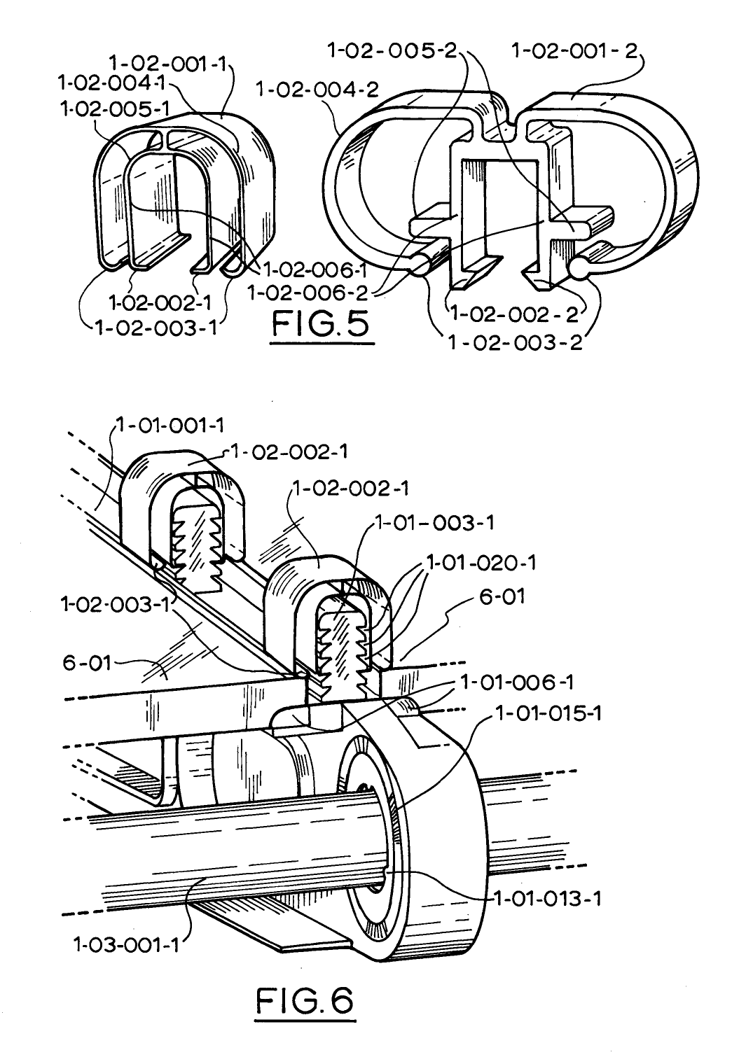

FIG. 5 illustrates the two embodiments of the solar panel restraining clip;

FIG. 6 illustrates the clip [first embodiment] assembled on an array fixing a PV panel;

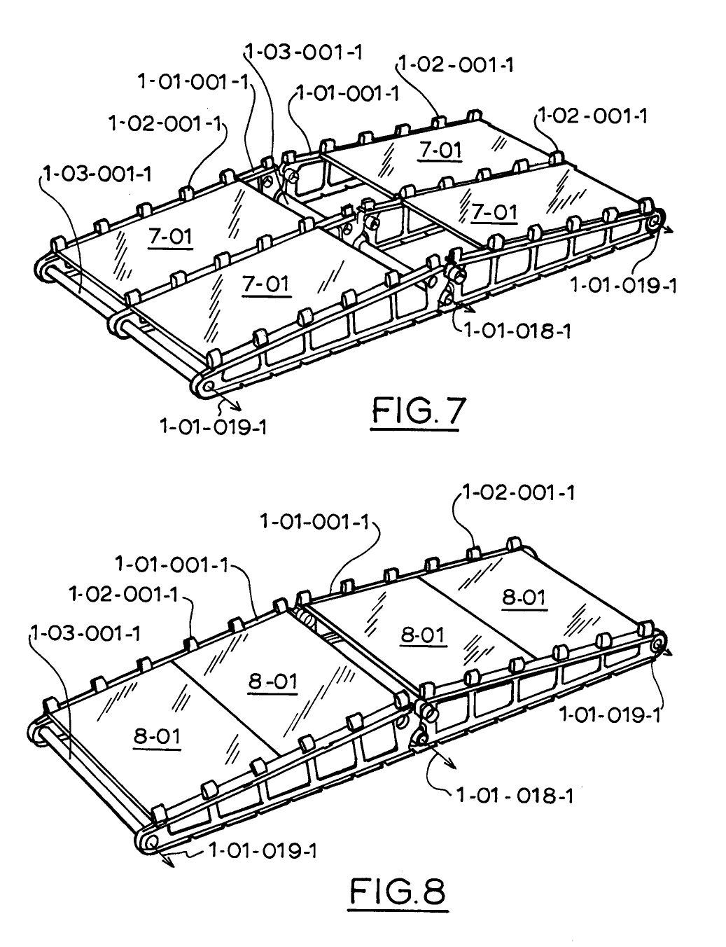

FIG. 7 illustrates an assembly of: Four REC Solar [1667×993 mm], panels mounted on six T-racks, fixed with retaining clips, in portrait orientation;

FIG. 8 illustrates an assembly of: Four REC Solar [1667×993 mm], panels mounted on four T-racks, fixed with retaining clips, in landscape orientation;

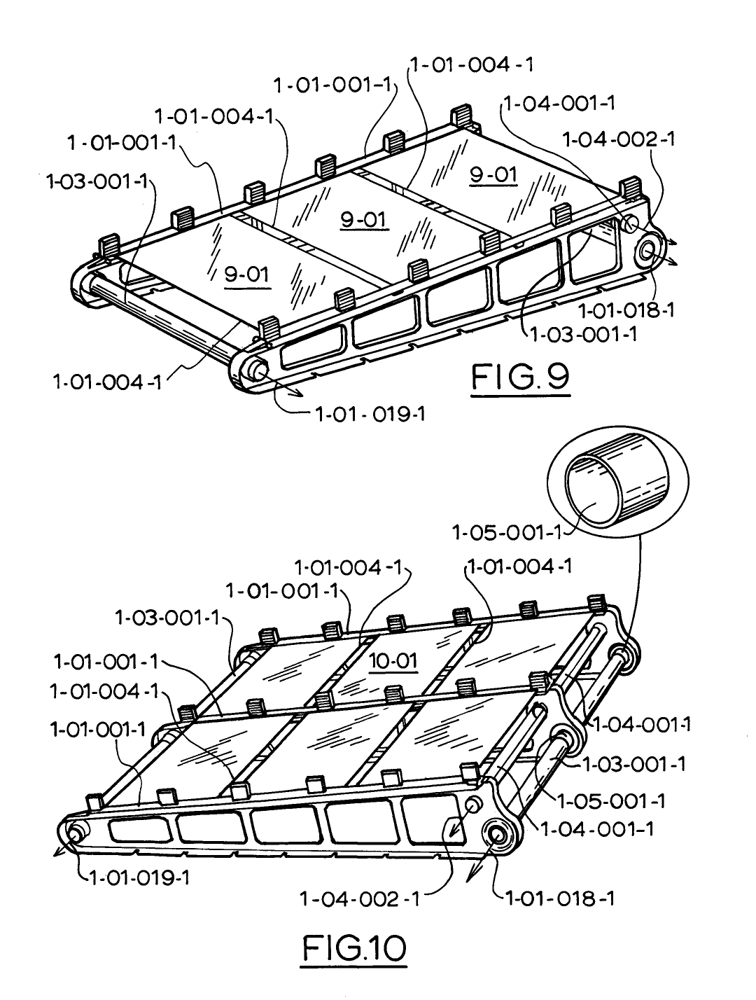

FIG. 9 illustrates an assembly of: Three First Solar [1200×600 mm], amorphous panels mounted on two T-racks, fixed with retaining clips, in landscape orientation;

FIG. 10 illustrates an assembly of: Six First Solar [1200×600 mm], amorphous panels mounted on Three T-racks, fixed with retaining clips, in landscape orientation illustrating connectivity, lateral fixing and wire management;

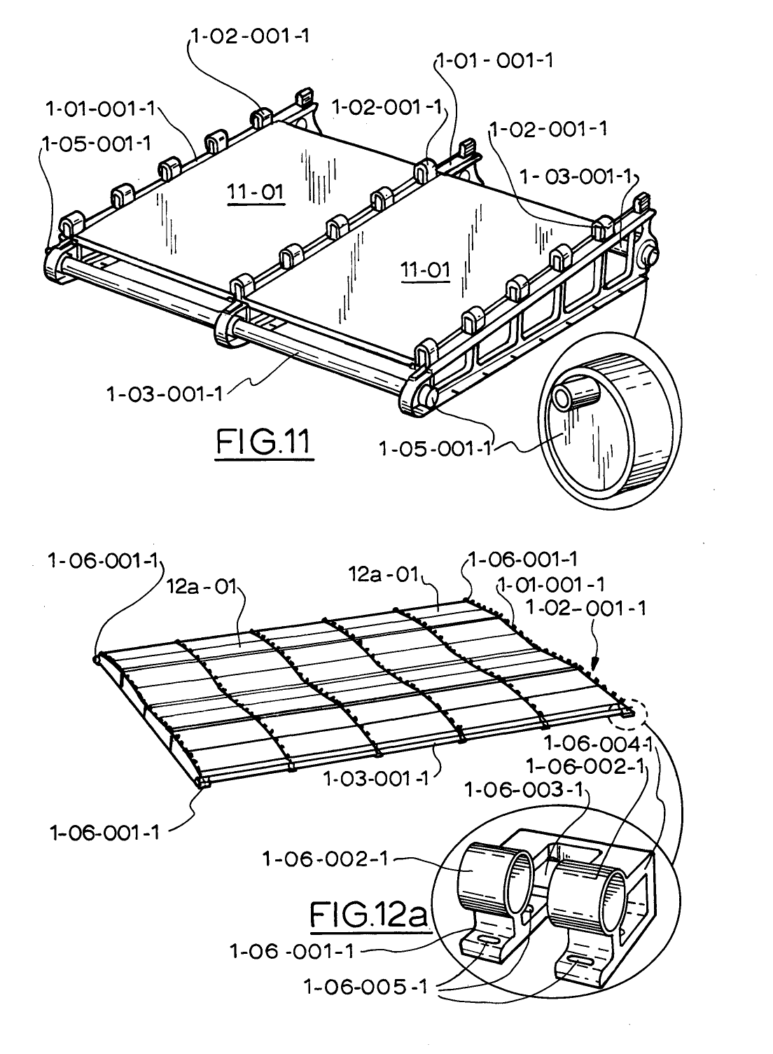

FIG. 11 illustrates an assembly of: Two REC Solar [1667×993 mm], panels mounted on three T-racks, fixed with retaining clips, in portrait orientation, illustrating water/sand ballast caps;

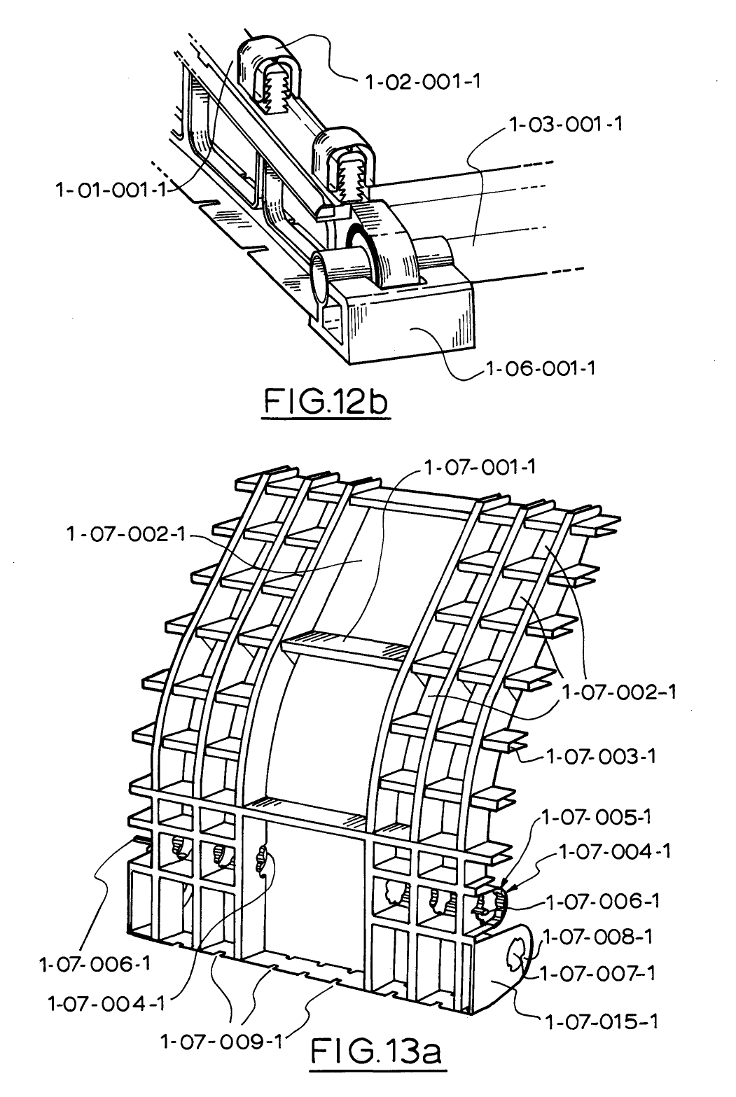

FIG. 12a illustrates an assembly of: Fourty REC Solar [1667×993 mm], panels mounted on twenty four T-racks, fixed with retaining clips, in landscape orientation with longitudinal and lateral connectivity, illustrating corner and perimeter fixing;

FIG. 12b illustrates a magnification of the left bottom corner of FIG. 12a;

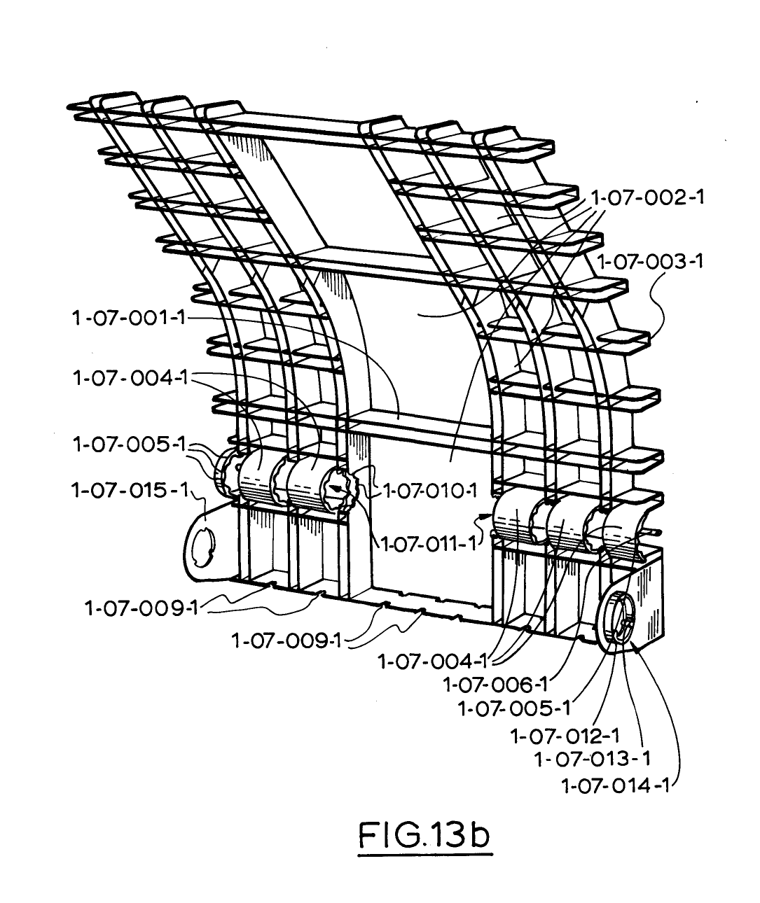

FIG. 13a illustrates a front view of the fence module;

FIG. 13b illustrates a rear view of the front fence module;

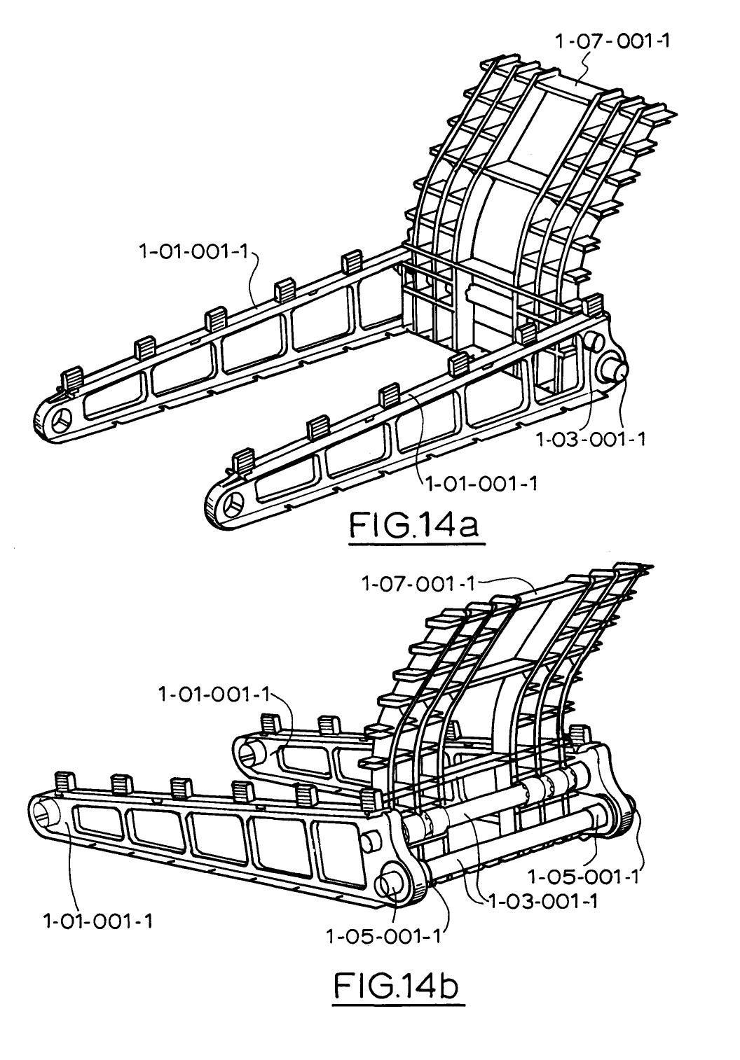

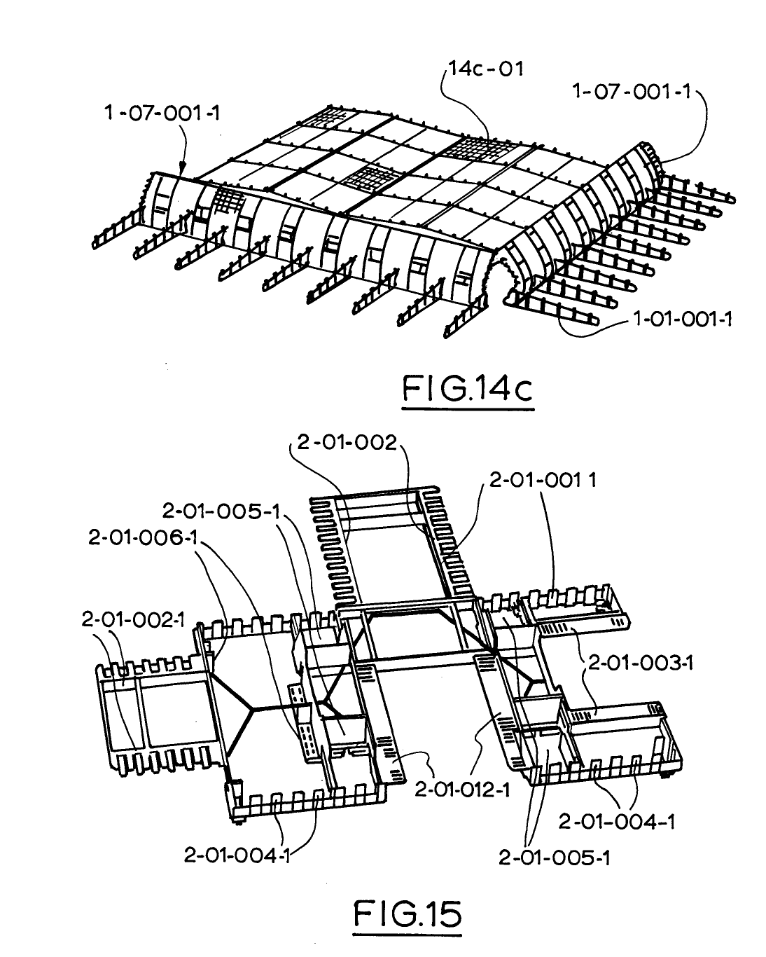

FIG. 14a illustrates a front view of the fence module connected to two T-Racks;

FIG. 14b illustrates a rear view of the FIG. 14a-assembly [above];

FIG. 14c illustrates a view of the FIG. 12a array fenced on two sides;

FIG. 15 illustrates a top view of the residential quarter [Q] rack;

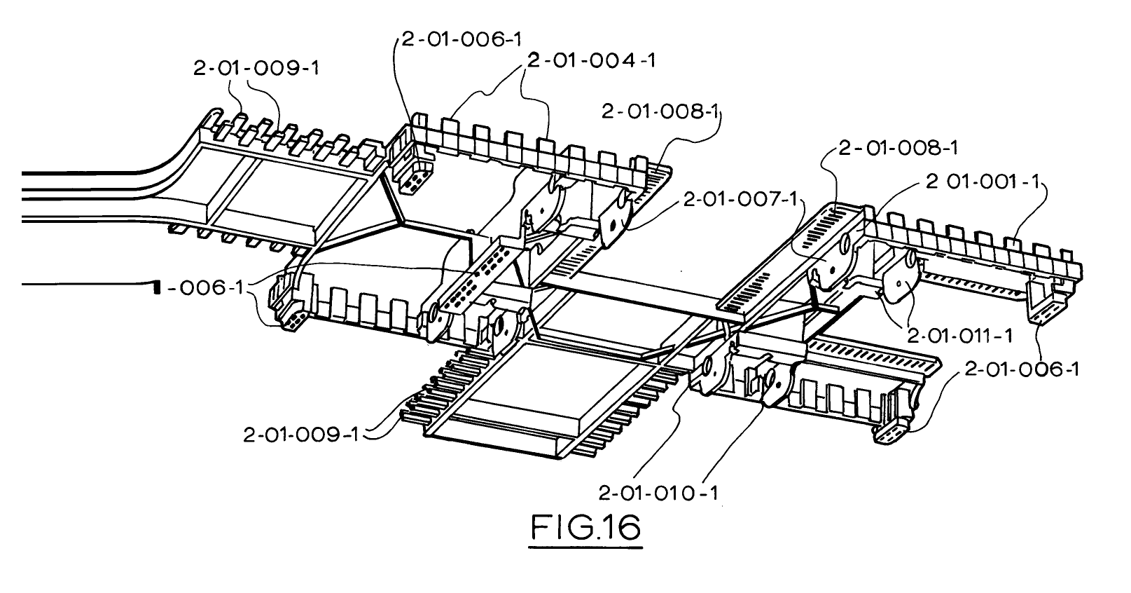

FIG. 16 illustrates the bottom view of the Q-rack;

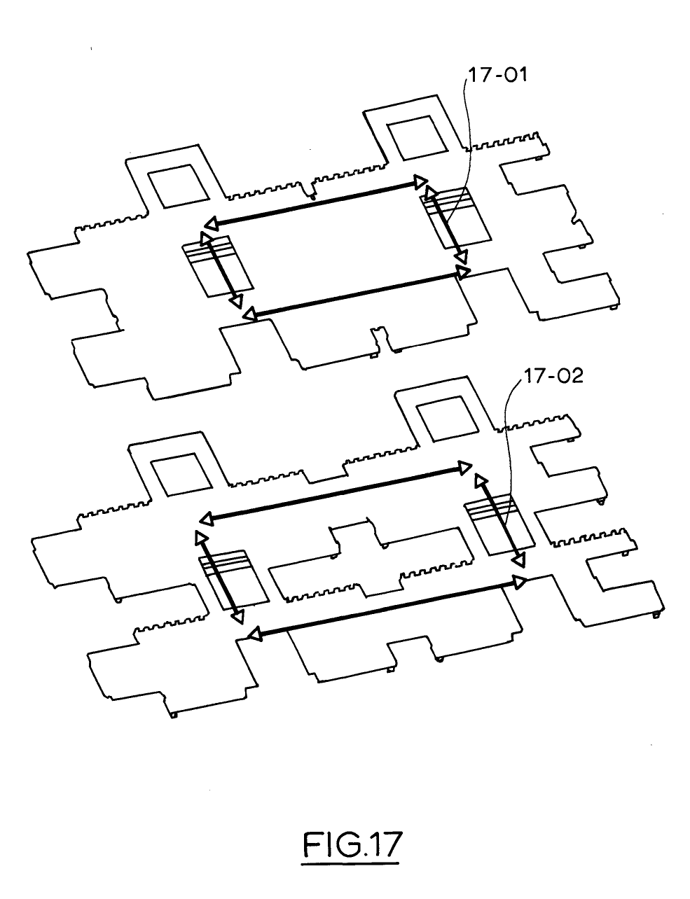

FIG. 17 illustrates four Q-racks in expanded and contracted views;

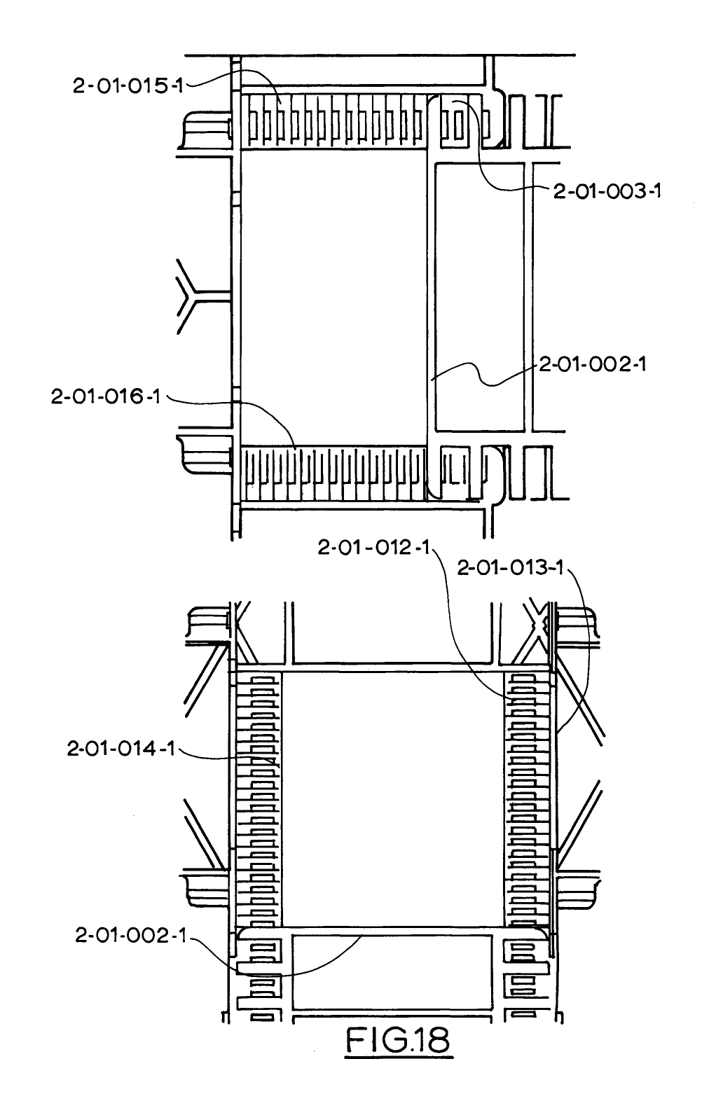

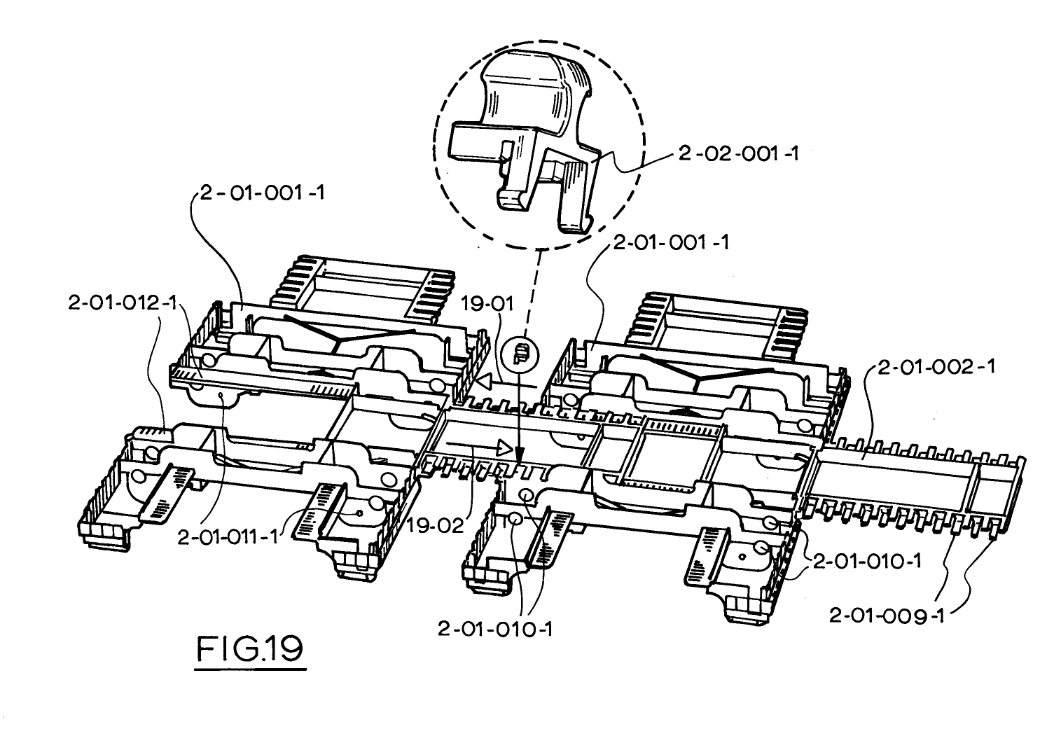

FIG. 18 illustrates the Q-rack horizontal and vertical adjustment systems;

FIG. 19 illustrates the adjustment clip and its placement;

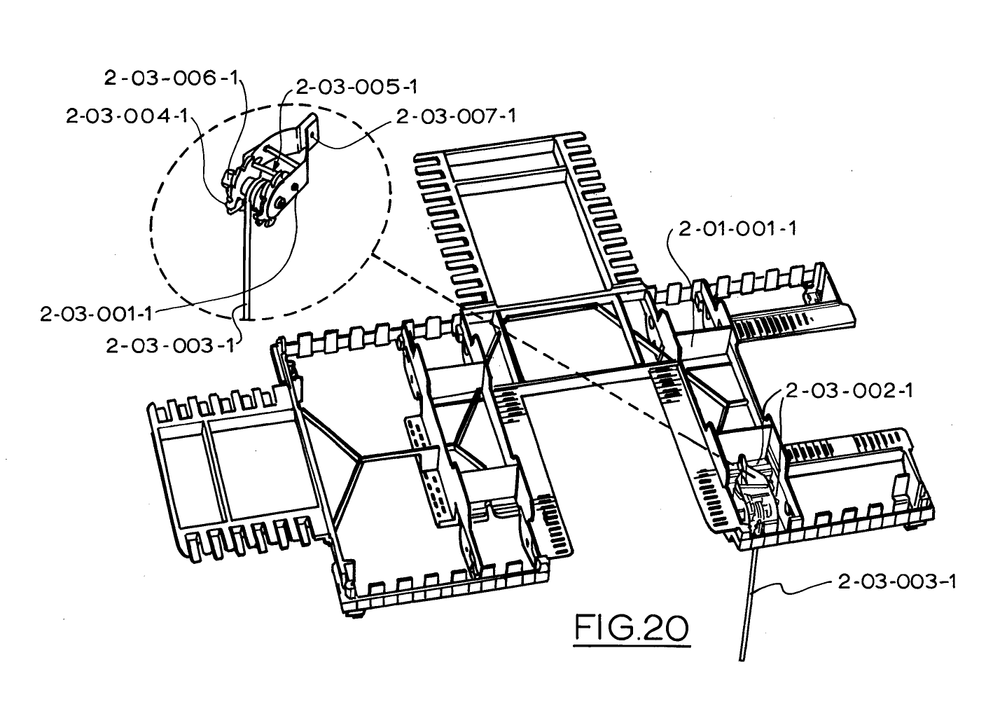

FIG. 20 illustrates the ratchet wire strainer and its placement in the Q-rack;

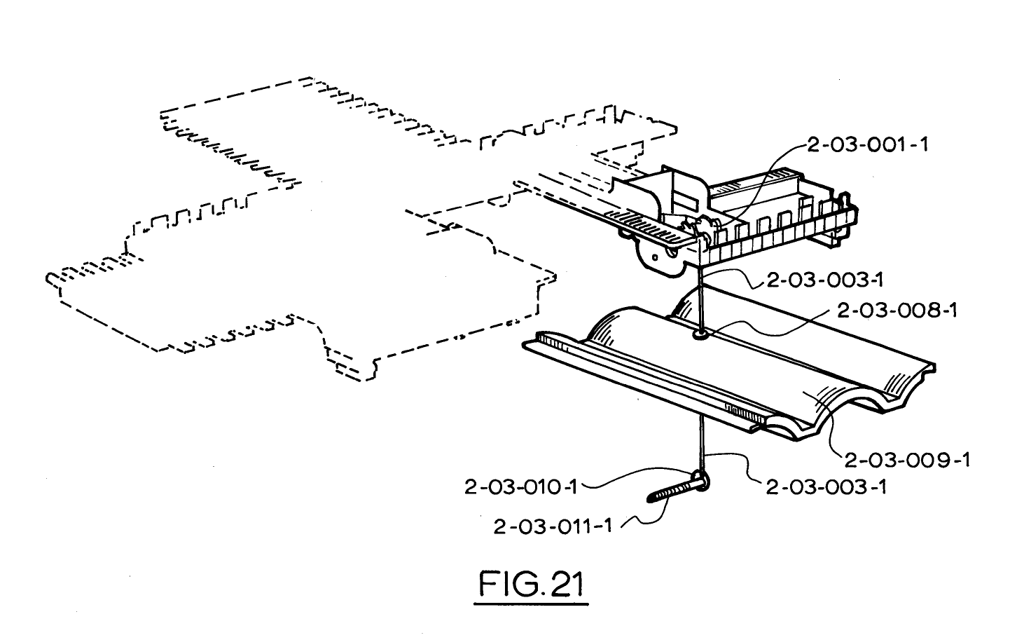

FIG. 21 illustrates the tile penetration and wire fixing system;

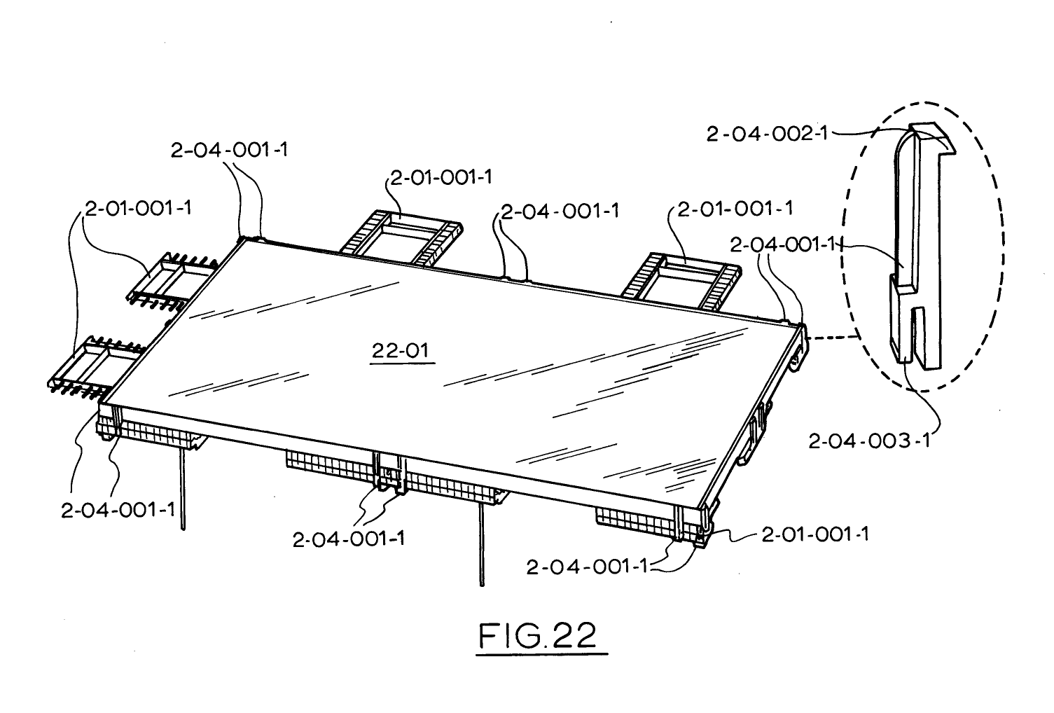

FIG. 22 illustrates the PV panel fixing clip and its positioning;

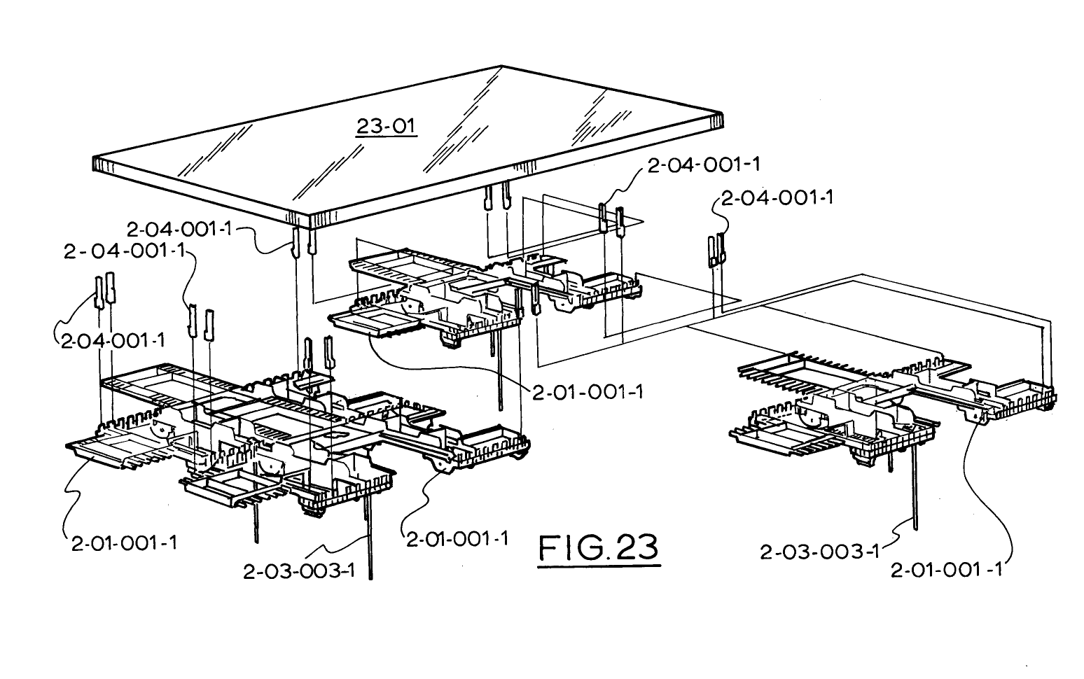

FIG. 23 illustrates an explosion of a REC PV panel fixed in a Q-rack assembly;

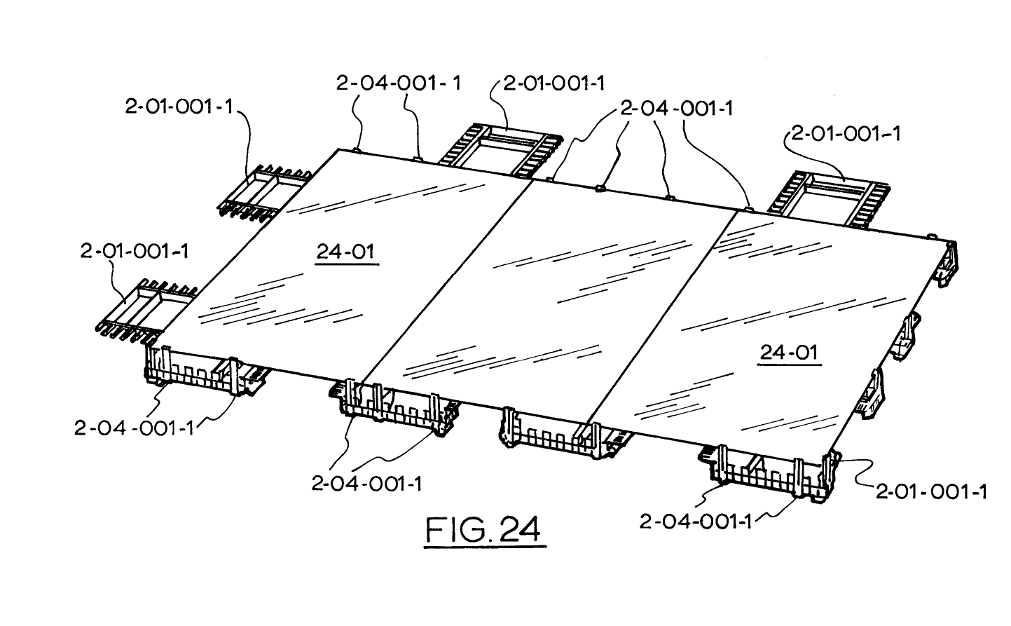

FIG. 24 illustrates an assembly of three, first solar PV panels fixed in a Q-Rack assembly with PV clips.

After careful consideration and the examination of the effects of elemental forces created by wind with speeds in the order of 38 meters per second [ie: 85 mph or 137 km/h], as applied to commercial and domestic solar racking designs, the loading resistance and factor of safety required for several test injection moulded form factor designs was determined.

A wind study was commissioned for the required PV angle and deployment strategy on typical commercial rooftop buildings.

The wind tunnel derived pressure coefficients results were then compared to the national wind loading codes of the proposed territories of deployment for reference. Each design was analysed using finite element analysis [or FEA] procedures on the said designs.

The goal was to develop the strongest most practical and adaptable design for each required application. The design criteria was based on:
Simplicity;
Minimal part number;
Extension slide and click-n-clip features only available with moulded plastic parts;
Part FEA's complying to the wind study results with a minimum 1.5 factor of safety.

The said invention will be described firstly in its basic components, which in assemble to form major assemblies. All parts [unless otherwise stated], are injection moulded from High Density Poly Ethylene Structural Foam. Each of the said assemblies that are the building blocks of the invention will be described in the sections below:

When considering solar panel frame sections, the solar panel frame heights vary from 6.8 mm to 50 mm, and the solar panel sandwich consisting of:
(1) Glass cover—varying between 3.2-4 mm;
(2) EVA [Ethyl Vinyl Acetate] encapsulation film: 0.5 mm;
(3) Conductive metallic strips: 50 microns (0.05 mm);
(4) The Solar Cells: 160-240 microns (0.016-0.024 mm);
(5) EVA [Ethyl Vinyl Acetate] encapsulation film: 0.5 mm;
(6) Backing substrate or glass 2-4 mm.

The combined max-to-min estimated thickness variability is: 6.2-9 mm.

From the above determination it was resolved that fixing the solar panel via the sandwich thickness variability was more practical than fixing via the frame height variation, provided multiple fixing points were used.

A further evaluation of the top 24 solar panel manufacturers in the 2012 Forbes Sustainable Growth Index, revealed that the bottom PVP frame width, of over 90% fell between 30-to-35 mm in width.

Section 1: The Truss-Rack

FIG. 1 illustrates the major design components of the Truss [T] rack [FIG. 1, 1-01-001-1].

The T-rack is a wedge shaped part, the acute angle feature, is designated as the front.

The T-rack top incorporates moulded ‘clip’ extrusions [FIGS. 1, 2, 3 & 6, 1-01-003-1], that allow for a vertical adjustment of 50 mm, through five saw tooth profiled ribs [FIG. 6, 1-01-020-1]. The clipping nook point in-between clearance, its number and separation accommodates for all framed solar panel extrusion widths. Un framed Solar panels [ie: the First Solar panels], are accommodated via lateral slots [FIGS. 1, 2, & 3, also installed FIGS. 9 & 10, 1-01-004-1]. The said slots are cut into a protrusion moulded on top section of the truss perimeter flange [FIGS. 1, 2 & 3, 1-01-002-01]. Either end of this said top flange section, are moulded stops [extrusions], providing upper and lower limits [FIGS. 1, 2 & 3, 1-01-006-1 & 1-01-006-1 respectively], to the placement of the fixed solar panels. The base of the perimeter flange has moulded slots [FIGS. 1, 2 &3, 1-01-009-1], providing fixing points should they be needed. The truss incorporates a central web [FIGS. 1 & 2, 1-01-007-1], with framed trapezoidal shaped cut-outs [FIGS. 1 & 2, 1-01-008-1], their placement and design determined via FEA analysis to provide maximum structural strength whilst minimising material volume. Moulded circular flanges [FIGS. 1, 2 & 3, 1-01-010-1, 1-01-011-1 & 1-01-012-1], provide receptacles for lateral tubular connectivity of parallel racks. Moulded ribs within these said receptacles [FIGS. 1, 2 & 3, 1-01-013-1], provide a vibration free mouldable, and minimal friction slide joint for a tubular fitting. Note that depending on the requirement other profiles such as square, rectangular, oval, ‘I’ section [or other shapes], could be used in place of the tubular system. The upper circular flange [FIGS. 1 & 2, 1-01-011-1], has three major functions:

1. When additional lateral stiffness [and/or ballast], is required in the array;

2. Placement of a cable management system [FIG. 10, 1-04-001-1] is required;

3. Perimeter fence fixing [FIGS. 14a & 14b, 1-03-001-1].

The other two lower circular flanges provide lateral and longitudinal connectivity between parallel and connected trusses respectively. The parallel connectivity is achieved through, as previously discussed, tubes [FIGS. 6 & 7, 1-03-001-1], inserted through the said flanges and as an example, in both directions along the axes [FIGS. 7, 8 & 9, 1-01-018-1 & 1-01-019-1].

Longitudinal connectivity is provided via a back-to-front, front-to-front or back-to-back mating of the two lower circular flanges. FIG. 4 illustrates the front-to-front and back-to-back mating of the trusses. FIG. 3 illustrates a ring of ribs [1-01-014-1], [a profile adjuster], which surrounds both front and back flanges [see FIGS. 1 & 2]. The ribs are set up such that a minimal adjustment [ie: a shift between each circular rib], corresponds to a rotation of 1.5 degrees. Note other finer or coarse adjustments can also be implemented. The said adjustments allow for the profile fitting of deployments, such as curved roofs or slopes. The profile adjuster is needed to provide longitudinal fixing to the array on horizontal or curved surfaces; it is locked in position via a collar [FIG. 10, 1-05-001-1]. The said collar provides lateral fixing as well.

FIG. 5 illustrates the two embodiments of the solar panel retaining clips. Clip [1-02-001-1], is a metallic aluminium extrusion, the clip fingers/arms [1-02-002-1], fit exactly in the sawtooth recesses of their truss ‘clip’ extrusions, the clamping pre-stress and clamping capacity has been evaluated via FEA modelling of the support [1-02-006-1], and curved [1-02-005-1], connective elements. Two other PV panel restraint arms [1-02-004-1], with curved ends [1-02-003-1], have been designed in a similar manner to provide a pre-stress clamp force to the PV panel to eliminate vibration through elemental action. Note: the metallic clip is the preferable embodiment due its conductive capability acting in a dual capacity of fixing element and earth bridging conductor.

Clip [1-02-001-2], is a plastic HDPE extrusion, the clip fingers/arms [1-02-002-2], fit Exactly [as with the previous embodiment in the sawtooth recesses of their truss ‘clip’ extrusions, the clamping pre-stress and clamping capacity has been evaluated via FEA modelling of the support [1-02-006-2], connective elements. Two other PV panel restraint arms [1-02-004-2], with curved ends [1-02-003-2], have been designed in a similar manner to provide a pre-stress clamp force to the PV panel to eliminate vibration through elemental action. There is an extra moulding in this embodiment [1-02-005-2], which limits the movement of the said curves ends—thereby enhancing the anti vibrational action.

FIG. 6 illustrates clip [1-02-002-1], fixed onto truss clip extrusion [1-01-003-1], clamping two PV panels [aspect: 6-01], positioned against the limit extrusions [1-01-006-1].

FIG. 7 illustrates an array of four REC solar panels [aspect: 7-01], deployed in portrait mode with restraining clips [metallic], and lateral connective tubes.

FIG. 8 illustrates an array of four REC solar panels [aspect: 8-01], deployed in landscape mode with restraining clips [metallic], and lateral connective tubes.

FIG. 9 illustrates an array of three first solar panels [aspect: 9-01], deployed in landscape mode with lateral connective tubes.

FIGS. 7-9 illustrate the adaptability of the rack to different orientations and types of PV panels.

FIG. 10 illustrates an array of six first solar PV panels [aspect: 10-01], deployed in landscape mode with lateral connective tubes, and a tubular wire management system [1-04-001-1], placed through the upper circular flange in the rack array. Also as discussed earlier this drawing illustrates the collar placement—Note not shown in other illustrations.

FIG. 11 illustrates an array of two REC solar panels [aspect: 11-01], deployed in portrait mode, and the use of the tubular connectors as ballast containers. By capping the ends of the tubular restraints [FIG. 11, 1-05-001-1], the tubes become containers and can be filled with sand, water or other suitable ballast material to aide with wind lift mitigation in parts/sections of high lift [eg: along the edge of a building], or the entire array. [1-05-001-1] Illustrates a water pipe type inlet/outlet fitting—any type fitting can be applied here, according to the requirement. Water ballast can be added [for example], on the probability of the onset of a statistically very rare wind event, and removed after it's passing to insure the integrity/stability of the array in the duration of the event.

FIG. 12a illustrates an array of 40 PV panels [aspect: 12a-01], deployed in landscape mode, utilizing 24 trusses on a horizontal surface. The said figure also illustrates a lateral fixing device [1-06-001-1], which can be installed at any ‘convenient’ position along any lateral perimeter connective tube. The fixing device is designed to slip around the end of the truss whilst being ‘threaded’ via the lateral connective tube. FIG. 12a illustrates one such device on each corner of the array; internal deployment of other similar fixing devices is not shown. The device is fixed to the deployed surface through slots [1-06-005-1]. FIG. 12b illustrates a magnified view of the bottom left hand corner of the array illustrating the placement of the fixing device.

Section 2: The Perimeter Fence

One of the most useful aspects exploited in this invention is the adaption of using a perimeter fence. Under specified conditions, the perimeter fence mitigates the formation of corner vortices, and accordingly alleviates the lift produced by the creation of the said vortices. The advantage of the perimeter fence is that it permits a larger area of coverage on commercial roof deployments; via lift mitigation and/or enabling the placement of solar panels on critically designed [or under designed] roofs in particular the countries of the Asia-Pacific region.

More specifically the wind study results indicate significant load reductions at the perimeter and corners of the deployed array with an additional general averaging of the wind loads across to the central areas of the array.

FIG. 13a illustrates a front view of the fence module [1-07-001-1]. The said module was designed to fulfil three conditions:
1. Modularity with an adaptive connectivity to the rack . . . utilizing the rack as the major down [ground], fixing component [see FIGS. 14a & 14b];
2. Quick and easy installation utilizing the two rear [upper and lower], lateral tubular fixing points and collars [see FIG. 14b, tubes: 1-03-001-1];
3. A blunt front mesh type air-foil profile [FIG. 13a, 1-07-003-1], with a specific wind porosity requirement [FIGS. 13a & 13b, 1-07-002-1]. A preferred wind porosity is 60% so that only 60% of the wind passes through the fence.

Downward [ground], fixing of the fence is assisted via slots [FIGS. 13a & 13b, 1-07-009-1].

The top tubular half ring mouldings [FIGS. 13a & 13b, 1-07-004-1], into which the fixing tubes are inserted [along centre line FIG. 13b, 1-07-011-1], have been designed with internal sinusoidal ribs [FIGS. 13a & 13b, 1-07-005-1], to reduce the tubular insertion assembly friction, with corresponding lobe cut-outs on the rear air foils [FIG. 13b 1-07-010-1]. An extra stabilizing arm [FIGS. 13a & 13b, 1-07-006-1], has been placed at both LHS & RHS connection points to increase the rack joint integrity and reduce the possibility of connective vibration due to wind buffeting loads. The bottom tubular connection is made through holes [FIG. 13a, 1-07-007-1], cut through the LHS and RHS flanges [FIGS. 13a & 13b, 1-07-014-1 & 1-07-015-1, respectively]. Sinusoidal lobes [FIG. 13a, 1-07-008-1], are incorporated into the LHS flange hole cuts, to reduce the tubular insertion assembly friction; on the RHS flange the same cut profile has been extruded [FIG. 13b, 1-07-012-1 & 1-007-013-1], to optimise mating with the opposite side of the rack [see FIG. 14b].

FIGS. 14a and 14b, illustrates a single fence module [1-07-001-1], with two racks [1-01-001-1], assembled on both sides; and the tubes: 1-03-001-1]. The said FIGS. also illustrate a third collar [FIGS. 14a & 14b, 1-05-001-1], component; this part ‘locks’ the above parts in place securing the integrity of the fence.

FIG. 14c illustrates the previous 40-panel rack array [aspect: 14c-01], from FIG. 12a, fenced on two sides. The illustration demonstrates the system modularity, assembly and expandability.

Note: As with the array assembly the fence can be either temporally or permanently ballasted as required. The fence is usually recommended in locations where wind speeds above 38 m/s are common. Use of the fence makes tethering unnecessary as the fence is designed to reduce the upward lift on the panel array caused by wind.

Section 3: Pitched Roof Racking System

The Fukashima disaster has shed more insight on the benefits of solar power generation. However the mountainous terrain of Japan does not easily lend itself to large commercial flat roofed buildings, highlighting the need for new and innovative-pitched roof solar mounting systems.

The current and preferred design incorporates multi panel carrying adaptability as well as reduced tooling cost with a standard steel roof fitting capacity and a unique tile, shingle etc. application system.

FIGS. 15 & 16, 2-01-001-1, illustrate top and bottom views of a quarter [Q] size rack. This racking system is designed around four Q-racks, interconnected via sliding lockable biscuit joints [FIG. 17 aspects 17-01 & 17-02], forming a single multi size adaptable solar rack. Once locked in position the said rack can be expanded similarly to form larger arrays. The vertical biscuit plug [FIG. 15, 2-01-002-1], incorporates slotted slides [FIG. 16, 2-01-009-1], either side of the biscuit, moulded via a bypass shutoff technique. The said slots fit top and bottom of the socket extrusion [FIG. 15, 2-01-012-1], when the biscuit is inserted into the socket via the said extrusion [see FIG. 19 aspects 19-01 & 19-02]. A series of five millimetre wide slots are moulded into both socket extrusions [FIG. 18, 2-01-013-1 and 2-01-014-1], separated by 5 mm in both cases but the left side offset by 2.5 mm. A moulded locking insert [FIG. 19, 2-02-001-1] will lock both sides in the required aligned position [see FIG. 19]. By only locking the RHS slots, achieves locked positional adjustments of 5 mm. By locking both sides in sequence adjustments of 2.5 mm are achieved. Each position/graduation is marked and the vertical capacity is identified [FIG. 18, 2-01-014-1 & 2-01-013-1]. The Q-rack is capable of a vertical adaptability from 990 mm to 1200 mm. A similar system applies to horizontal adjustment.

A horizontal biscuit plug [FIG. 15, 2-01-002-1], incorporates slotted slides [FIG. 16, 2-01-009-1], either side of the biscuit, moulded via a bypass shutoff technique. The said slots fit top and bottom of the horizontal socket extrusion [FIG. 15, 2-01-003-1], when the biscuit is inserted into the socket via the said extrusion. A series of five millimetre wide slots are moulded into both horizontal socket extrusions [FIG. 18, 2-01-015-1 and 2-01-016-1], separated by 5 mm in both cases but the left side offset by 2.5 mm. By locking both sides in sequence adjustments of 2.5 mm are achieved. Each position/graduation is marked and the vertical capacity is identified [FIG. 18, 2-01-015-1 & 2-01-016-1]. The Q-rack is capable of a horizontal adaptability from 1660 mm to 1800 mm.

The Q-rack is fixed to steel roofs through slotted holes [FIGS. 15 & 16, 2-01-006-1], located at the four corners of the Q-rack, and along side the LHS ratchet mounting enclosure [FIG. 15 2-01-005-1]. For tile, shingle and other similar style roofs, a penetration fixing is needed. FIG. 20, 2-03-00101, illustrates a standard wire strainer [FIG. 20, 2-03-001-1], with ratchet [FIG. 20, 2-03-004-1], spring [FIG. 20, 2-03-005-1], winder [FIG. 20, 2-03-006-1], and wire [FIG. 20, 2-03-003-1]. The said wire tensioner can be fitted in four positions in each Q-rack [FIG. 16, 2-01-007-1]. The said wire strainer is locked into position via two shaft-bolts [FIG. 20, 2-03-002-1]. FIG. 21 illustrates the fixing wire [FIG. 21, 2-03-003-1], the tile [FIG. 21, 2-03-009-1], the sealing grommet [FIG. 21, 2-03-008-1], and its penetration, with the eyelet on the end of the wire [FIG. 21, 2-03-010-1], and the fixing wood screw [FIG. 21, 2-03-011-1]. Note; the grommet can be replaced by a (commercially available), sealed boot, which surrounds and seals

The mounting and fixing of the solar panels methodology is similar to the flat roof commercial T-rack system—where the PV panel is clamped between the solar panel and frame as illustrated in [FIG. 7, section A-B]. The solar panel backing sheet rests on the top of the four wire strainer frames [FIG. 15, 2-01-005-1], whilst the top of the frame is fixed via edge clamp [FIG. 22, 2-04-001-1]. The said edge clamp can be fixed in any position between the Q-rack perimeter castling [FIG. 16, 2-01-004-1]. Note placement of the locking insert fixes the four Q-racks in position so that no in plane movement is possible. FIG. 22 illustrates a REC solar panel [FIG. 22, aspect 22-01], fixed with 16 edge clamps, and FIG. 23 illustrates an explosion diagram of the FIG. 22 assembly. FIG. 24 illustrates the Q-rack expanded to fit three First solar 1200×600 mm solar panels [FIG. 24, aspect 24-01].

This invention is particularly useful in:
1) Two applications of a similar system one for Commercial [flat] roofs and the other for commercial/domestic pitched roofs;
2) Intuitive array alignment via placement, slide and lock fitment of [B-B] and [F-F] truss and pitched roof racks;
3) Both applications being low cost, with clip-n-fit moulded plastic features and the general overall part number reduction, resulting in:
   a) Limited installation tooling requirement, and
   b) Rapid, intuitive and straight forward assembly;
4) FEA analysis and wind tunnel studies of the T-rack PV panel application with installed support infrastructure for optimised wind pressure evaluation;
5) Both applications have the capability to support several different panel types and sizes—one product suits all inn each application;
6) The adaptive capability of the T-rack to support a perimeter fence system capable of ameliorating high wind loads by destroying the wind induced edge vortices;
7) The polymer master batch used when manufacturing the rack can be infused with Titanium dioxide, imparting a white colour with high degree [>90%], of reflectance to the rack assembly enhancing the passage of reflective light through the said cavities allowing the energisation of dual sided [ie: top and bottom], solar panels;
8) Both applications featuring load spreading support/fixing design via a large number of PVP sandwich supporting fingers eliminating high load concentrations in the PVP frame.

This invention includes the following benefits.
The modular parts can be quickly assembled to form a high strength plastic support infrastructure with a high degree of integrity/reliability;
The T-racking system requires limited or no ballasting through perimeter fixing and may be fixed/aligned into any angular position;
The T-racking system may be perimeter fenced, locally or fully ballasted either temporally or permanently;
Both rack array systems may be installed onto any size or shape of commercial building roof according to user requirements, the T-rack can also be installed on land base deployments;
The T-rack system incorporates simple and adjustable longitudinal and lateral connective systems;
The T-rack system provides an integrated lateral wire management system;
The T-rack array may be installed on ‘long/gentle’ sinusoidal or curved surfaces;
The T-rack can accommodate most large size commercial PV panels in both portrait and landscape orientation;
The T-rack may accommodate thin amorphous PV panels such as the first solar amorphous products;
The T-rack array may incorporate a perimeter fence which has been tested to ameliorate/dampen the effect of wind generated edge vortices, responsible for the major production of the edge lift force components;
The said fence deployment increases the roof coverage ratio [RCR], of commercial roof deployment, thereby increasing the power generating effectiveness of the array;
Both racking systems allow for the material thermal-diurnal and seasonal cycling—of expansion and contraction;

Those skilled in the art will realise that this invention provides a unique material/assembly to provide an unballasted solar racking system, with optimal connectivity, installation speed and contiguous array strength, that will resist wind induced lift forces, whilst maximising commercial roof coverage ratio.

Those skilled in the art will realise that the present invention may be made in embodiments other than those described without departing from the core teachings of the invention. The modular platform may be adapted for use in a range of applications and sizes and can be shaped to fit the requirements of the desired application.

1. A modular rack array for supporting solar panels comprising:
solar panel hold down clips;
a plurality of longitudinal support racks, each longitudinal support rack comprising two longitudinal sides with solar panel support ledges on both sides and hold down clip receiving recesses located between each row of support ledges;
wherein a first solar panel is supported by two parallel support racks and additional solar panels are supported by an additional one of the support racks with the panel hold down clips being arranged to be secured to the support racks by clipping into the receiving recesses in said support racks and bearing down on the upper side of the solar panel edges so that two parallel edges of said first solar panel are held between the hold down clips and the support ledges of said support racks.

2. A modular rack array as claimed in claim 1 in which the support racks are wedge shaped and incorporate circular flanges at each end of the base of the rack to accommodate tubular connecting pieces to laterally connect the support racks into an array.

3. A modular rack array as claimed in claim 1 in which rack to solar panel ratio is:
$$\frac{{( T \text{-} rack )}^{Number ( n )}}{{( SolarPanel )}^{Number ( n )}} = [ \frac{n + 1}{n} ] .$$

4. A modular rack array as claimed 2 in which the tubular connectors are filled with water or other material to provide ballast.

5. A modular racking system as claimed in claim 1 in which the rectangular support racks are also used to support a perimeter fence around the array to ameliorate wind forces that may affect the stability of the array.

6. A modular racking system as claimed in claim 5 in which the fence panel has a blunt front mesh type air-foil profile with a wind porosity requirement of about 60%.

7. A modular racking system as claimed in claim 1 in which the solar panels are elevated to allow air flow beneath the panels enabling even under panel pressure distributions, reducing lift and increasing light penetration under the panel.

8. A modular rack array for supporting solar panels, the rack comprising:
a longitudinal wedge shaped support rack which has two longitudinal sides with solar panel support ledges on both sides and incorporate circular flanges at each end of the base of the rack to accommodate tubular connecting pieces to laterally connect the support racks into an array;
tubular connecting pieces;
a fence panel mounted on the tubular connecting pieces and said fence has a blunt front mesh type air-foil profile with a wind porosity requirement.

9. An array of solar panels supported on an array of modular racks as claimed in claim 8 in which the fence panels are a sinusoidal form and are arranged on the periphery of the array to ameliorate wind forces that may affect the stability of the array.

10. A modular rack array as claimed in claim 1 in which rack to solar panel ratio is:
$$\frac{{( T \text{-} rack )}^{Number ( n )}}{{( SolarPanel )}^{Number ( n )}} = [ \frac{n + 1}{n} ] .$$
